(19) United States
(12) Patent Application Publication
(10) Pub. No.: US 2014/0144294 A1
(43) Pub. Date: May 29, 2014

(54) Adjustable Open End Ratcheting Flare Wrench

(71) Applicant: Chi Sung Row, Norcross, GA (US)

(72) Inventor: Chi Sung Row, Norcross, GA (US)

(21) Appl. No.: 13/740,795

(22) Filed: Jan. 14, 2013

Related U.S. Application Data
(63) Continuation-in-part of application No. 13/684,517, filed on Nov. 24, 2012, now Pat. No. 8,596,168.

(51) Int. Cl. B25B 13/46

(52) U.S. Cl. CPC B25B 13/46
USPC 81/111

(57) ABSTRACT

The invention comprises a ratchet style flare nut wrench which incorporates an assembly to provide a torqueing function and ratchet effect. The assembly includes a wrench body capable of providing torque delivery through three rotating cylindrical cams which contact the nut. The cylindrical cams then rotate when reversing the direction of the wrench assembly so that a cutout portion of the cylindrical cams allows the nut points to pass by. Two cylinder cams are mounted on movable guide blocks which adjust the wrench for different size nuts.

### CROSS REFERENCE TO RELATED APPLICATIONS

This application is a continuation in part of U.S. patent application Ser. No. 13/684,517, filed Nov. 24, 2012. The entire prior application is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward open ended wrenches, in particular, to wrenches that incorporate elements and features that are useful for allowing a wrench to loosen/tighten a nut (or bolt) without removing the wrench from the fitted position on the nut.

(2) Description of Related Art

Wrenches are useful for a variety of tightening or loosening situations when applied to nuts and bolts, and some are designed to provide a ratcheting effect. However, flare nut wrenches are not easily configured to a ratcheting method, and there is no method provided for using a single wrench for a variety of nut sizes which are associated with different tubing line sizes.

In the connecting or tightening tubing lines together, common socket wrenches in the art not usable because the enclosed socket end cannot fit over the tubing and be removed at the end of the job. Also, common two point contact wrenches, such as adjustable end wrenches or open end wrenches, are less desirable because the tubing fittings are often brass (a relatively soft metal) and are easily rounded when torqueing the nut to the desired specification.

A common, manual flare nut wrench has been designed for the tightening operation because it grips the nut in multiple places. It has an opening on one side to slide over the tubing and then can be slid over the nut. However, in actual use, this type of wrench is frustrating because it must constantly be slid off and on the nut during the tightening sequence. The use of this type of wrench, of necessity, is time-consuming.

Some attempts have incorporated a ratchet effect to improve the speed at which the tightening can occur, and specifically designed for flare nut wrench. US 12/780,853 is an example.

However, flare nut wrenches have the additional disadvantage of being fixed in size. No effort has been put forth to design a practical wrench that allows one wrench to accommodate a range of nut sizes, and additionally, provide for a ratchet effect.

It is desirable to not only include a ratchet feature, but to incorporate features to adapt the tool to varying nut sizes, as it is also frequently the case where a wrench is put on a nut only to discover that the wrong wrench size was selected. This occurs when the nut is at an awkward position with respect to the user of the wrench, and where it is not instantly obvious what size wrench should be selected.

### BRIEF SUMMARY OF THE INVENTION

The invention comprises a ratchet style open end wrench assembly which incorporates an assembly to provide a torqueing function and ratchet effect. The assembly includes a wrench body capable of providing torque delivery through three rotating cylindrical cams which contact the nut. The cylindrical cams then rotate when reversing the direction of the wrench assembly so that a cutout portion of the cylindrical cams allows the nut points to pass by.

### BRIEF DESCRIPTION OF THE SEVERAL VIEWS OF THE DRAWING(S)

FIGS. 1A-1B shows a rotating cylindrical cam of the invention including the cutout area.

FIGS. 2A-2B shows the right angle torque spring that is use to create the ratchet effect.

FIGS. 3A-3C show a preferred embodiment of the present invention where two cylinder cams are adjustable in position.

FIGS. 4A-4D shows various types of guide block assemblies.

FIG. 5 shows an exploded view of an assembly of the embodiment illustrated in FIG. 3A-3C.

FIG. 6 illustrates an additional embodiment with an alternate method of adjusting the position of the two movable cylinder cams.

FIGS. 7A-7D show how the assembled torque flare nut wrench is rotated in one direction for torque and the opposite direction for the ratchet effect.

### DETAILED DESCRIPTION OF THE INVENTION

The invention will provide torque capability in addition to ratchet capability, and additionally, accommodate a variety of nut sizes. This wrench is designed to address flare nut issues, and a hex nut in particular.

The primary object of this invention is to provide a wrench of the flare-nut and/or crow-foot type having a hexagonal jaw opening that can be fitted over a tubing or line and down onto the hexagonal connection or joint, and when once in place, it can be operated with a ratcheting action and the like without ever having to be removed; that is, the wrench from the tubing or line connection for purposes of securing a new grip for succeeding turns.

The invention will be compact in design, provided, however, that suitable materials are selected. The top cover plate and cylindrical cam design are important aspects which require careful design considerations. Suitable materials are primarily metals, in particular, steels and hardened steels, including metal coated steels such as chrome coated. Plastic materials are usable in selected areas such as for adjusting mechanisms and handles, and when used as coatings for metals.

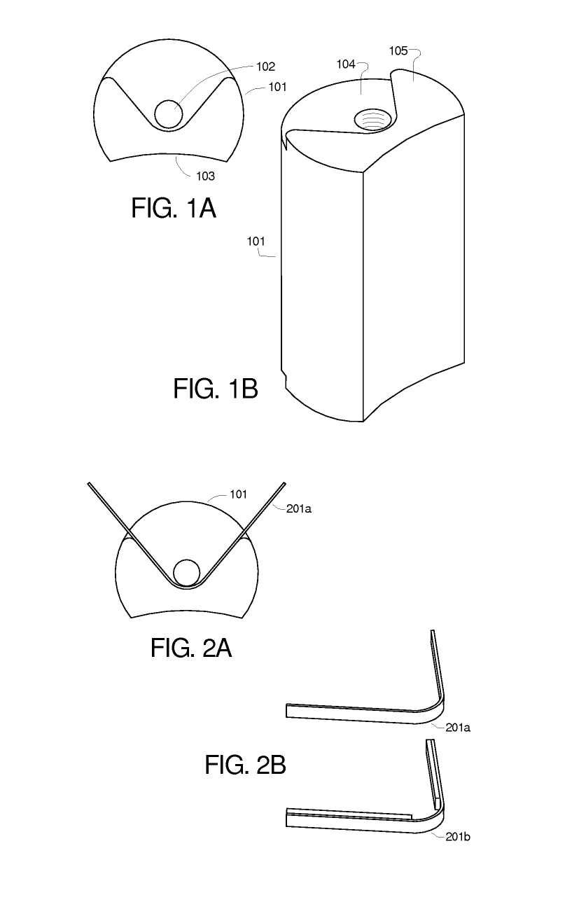

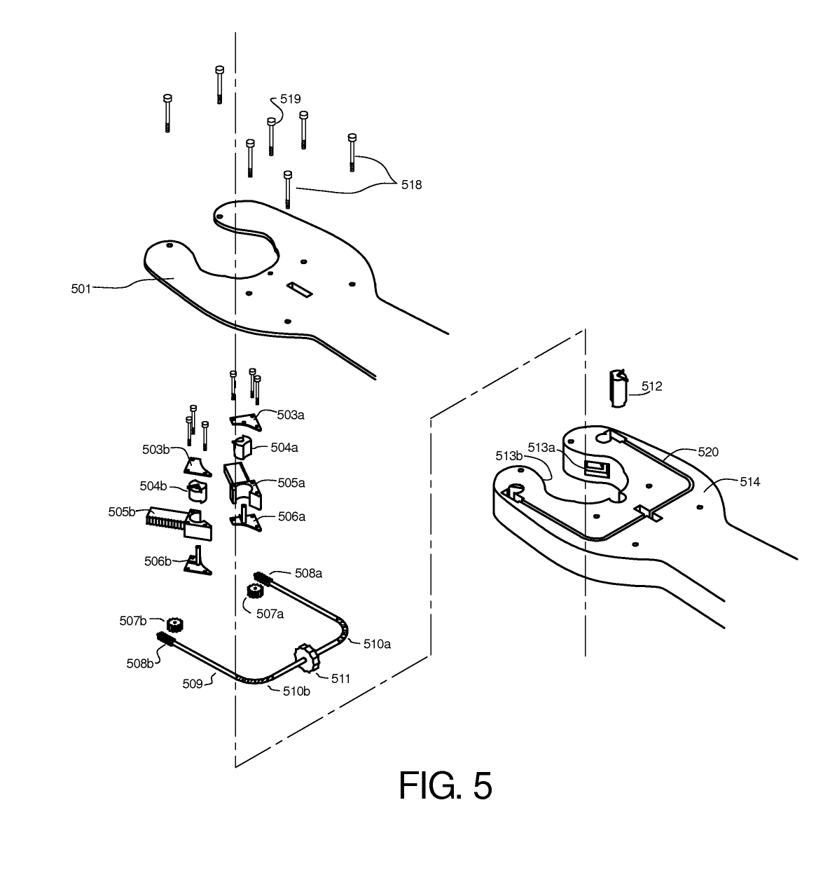

FIGS. 1A-1B show an isometric view of a rotating cylindrical cam 101 and a top view. The rotating cylindrical cam includes a machined area 103 which is used for the ratchet effect and allows the nut points to pass by the cam, and press against it to rotate it. The area could be in the shape of a circle segment (preferred) or in the shape of a straight line depending upon clearance tolerances between the nut and the wrench opening, or the size of the cylindrical cam. A hole 102 is provided for a pin (see FIG. 5). A recess area 104 is machined below the top area of the cylindrical cam 105 (and also on the opposite end) so that the cam will rotate when used with an associated right angle spring 201a (see FIG. 2B). Each cylindrical cam will have one right angle spring.

FIG. 2B shows two embodiments of a right angle torque spring 201a,b that are used to create the ratchet effect. Its location in the lower recessed area of the cylindrical cam (Area 104 in FIG. 1B) as illustrated in FIG. 2A, and pressed against the sides of the top area of the cylindrical cam (area 105 in FIG. 1B) as also illustrated. The right angle torque spring may be stiffened or weakened by varying the thickness and material used, and in one embodiment is a wire rather than the flat spring illustrated. In another embodiment, the right angle torque spring is a built up spring 201b where the thickness of the straight portions is greater.

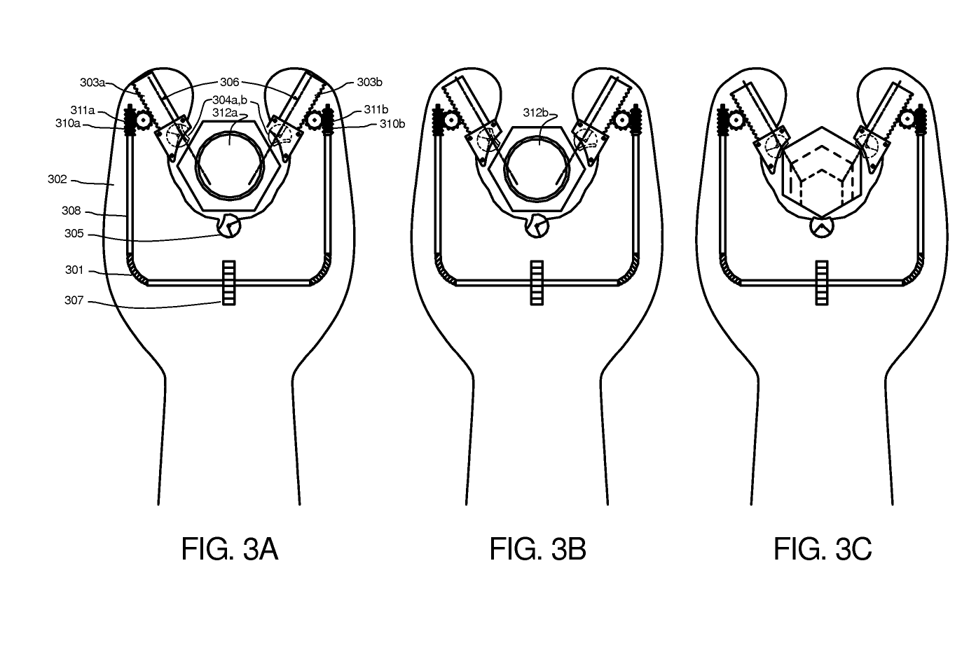

FIGS. 3A and 3B show cylinder cam arrangements suitable for flare nut wrenches which are useful for tightening nuts on tubing. A flare nut wrench is useful for brake lines, hydraulic lines, air conditioning lines, and higher pressure tubing. The wrench opening is designed to be larger than the tubing outside diameter, and the open end wrench is first slipped onto the tubing. Secondly, the wrench is then slipped onto the nut. In this case, three cylinder cams are used to develop the desired torque because the design also allows for a variable nut size.

As seen in FIG. 3A, a preferred embodiment of a ratchet flare wrench is shown. In this embodiment, a nut size adjusting mechanism is in place which allows two cylinder cams 304a,b to be adjusted in position based on the nut size. The moving or adjustable cylinder cams 304a,b are mounted on guide blocks 303a,b, which are moved by a thumbwheel 307. The thumbwheel rotates a drive train 308 which includes flexible 90 degree bends 301, and rotates end gears 310a,b. The end gears drive idler gears 311a,b which move the guide blocks 303a,b. The guide blocks 303a,b incorporate teeth which engage with the idler gear 311a,b teeth. The guide blocks must be set up at an angle 306 which is 60 degrees from each other and positioned so that the moving cylinder cams 304a,b on each guide block will touch approximately at the center of the hex nut. A fixed or wrench body cylinder cam 305 position does not vary with the size of nut. This is necessary for the ratchet effect to work correctly and to allow different size nuts to work. However, a universal size wrench is not desirable as a practical matter, a range of nut sizes 301a,b will be associated with each ratchet flare wrench. All of the hardware is mounted on the wrench body 302.

It should be noted that the gear train may include other designed connections than the ninety degree angle 306 shown. Depending upon the size of the wrench body, other angles could be chosen which will increase (or possibly decrease the angle) the angle to make the drive train more compact. Also, a greater angle may be easier to drive, depending upon the materials chosen.

FIG. 3C shows a rotated nut and how the guide adjustment is suitable for a variety of nut sizes (312a,b as shown in FIGS. 3A-3B). As shown, the movable guide blocks follow the corners of the nut as it reduces in size. This angle is optimum for orienting the motion of the two movable guide block assemblies.

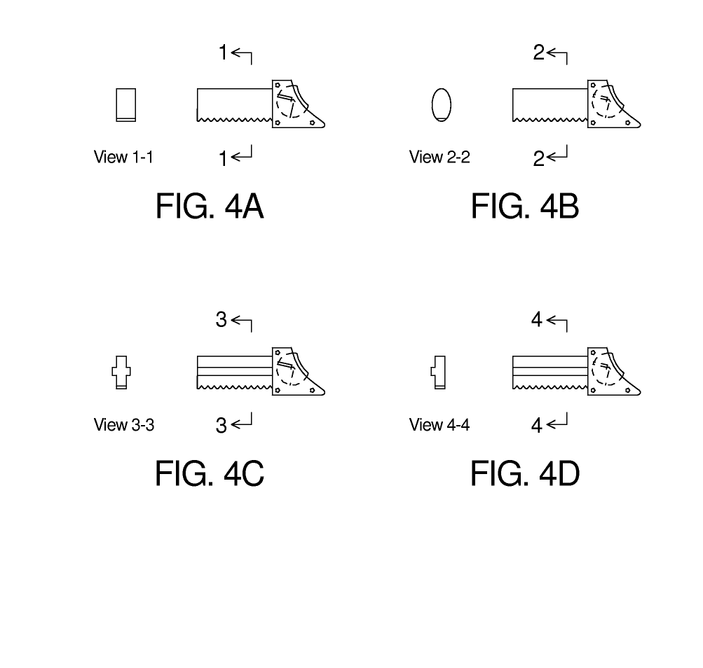

FIGS. 4A-4D show various types of guide block assemblies. The guide blocks are inserted into hollow cavities in the wrench body as illustrated in FIG. 5. FIG. 4A, for example, shows a guide block assembly that has a rectangular insert body shape. FIG. 4B is an ellipse body shape, FIG. 4C is a cross, and FIG. 4D is a rectangular cross section with a guide rail. All of these cross sections allow the guide blocks to move in and out toward the nut smoothly with a controlled movement so that the desired increase or decrease in nut size is properly accommodated. These illustrated guide block assembly body shapes are only illustrative, and not complete list of the possibilities.

FIG. 5 shows an exploded view of a preferred embodiment assembly. A top cover plate 501 is used to cover the guide block adjustment assembly. An end threaded pin or screw 519 acts as a pin for the cylinder ram 512 that is located in the middle of the wrench body. The two movable cylinder rams 504a,b are mounted inside the ends of movable guide blocks 505a,b which themselves also have guide block top plates 503a,b and guide block bottom plates 506a,b. The guide block bottom plates also have the needed pin and stops for the cylinder rams 504a,b. Stops (not shown) are also located under the guide block top plates 503a,b.

A thumbwheel 511 actuates drive train 509, including flexible 90 degree bends 510a,b, to rotate end gearing 508a,b. The end gearing then turns idler gears 507a,b to move the guide blocks 505a,b by use of machined teeth on one side. The left hand/right hand rotation of the two end gears 508a,b are chosen as so that a single rotating direction of the thumbwheel will coordinate the motion of the guide blocks 505a,b so that they both move in or out simultaneously.

The wrench body 514 has machined recesses 513a,b which are used to receive the guide blocks 505a,b along with their respective top and bottom plates, and additionally, their cylinder rams. Additionally, the wrench body has machined recess 520 for the thumbwheel drive system and idler gears.

A third, fixed cylinder ram 512, which is longer than the guide block cylinder rams 504a,b, is fitted into the wrench body. The machined recess in the wrench body includes a flat plate (not shown) to receive the cylinder ram pin 519 and includes a stop 517. Six screws 518 are used to complete the assembly of FIG. 5 and thread into the wrench body 514. An additional stop for the cylindrical ram (not shown) is under the top cover plate.

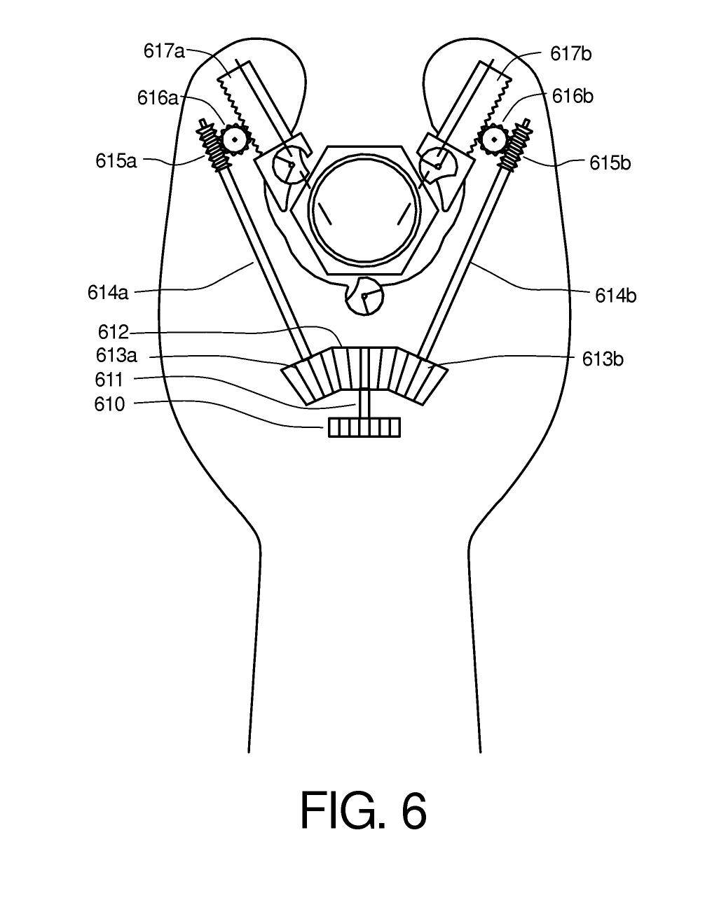

Another important embodiment is shown in FIG. 6. A thumbwheel 610 is rotated and drives a first shaft 611 which turns a main gear 612. The main gear 612 drives two spur gears 613a,b which drive second shafts 614a,b and worm gears 615a,b. The worm gears 615a,b turn idler gears 616a,b, which in turn, move the guide blocks 617a,b in and out in a coordinated manner as described before. Again, the design of the gearing is such that the guide blocks either move in together or move out together.

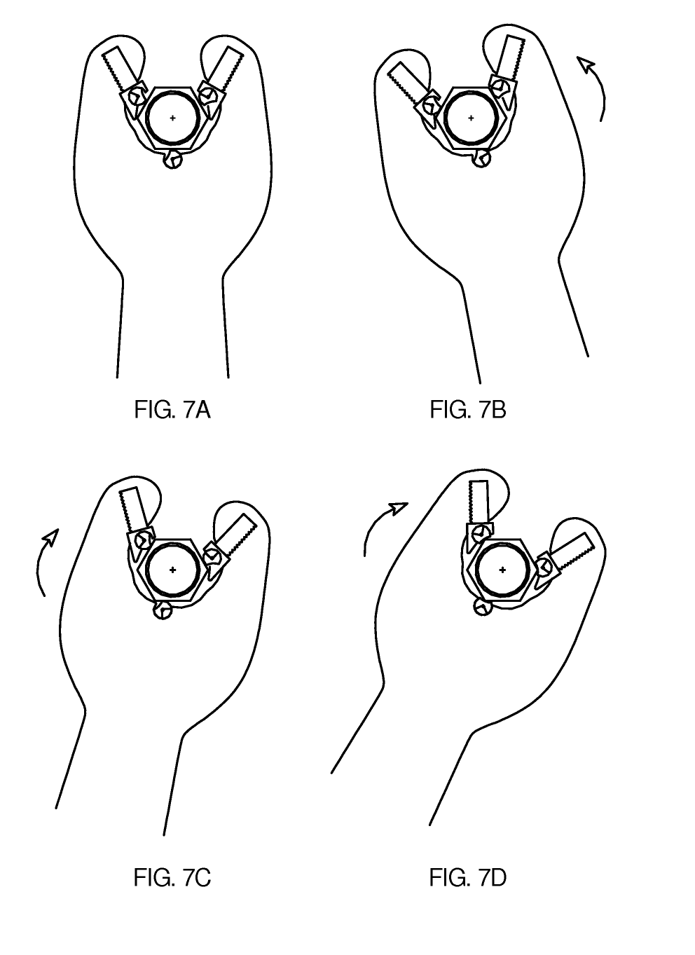

FIGS. 7A-7D show how the assembled torque flare nut wrench is rotated in one direction for torque and the opposite direction for the ratchet effect. In FIG. 7A, the cylinder cams are designed to almost touch on the hex nut at the mid-point on three faces as illustrated. When the wrench is rotated in the counter clockwise direction in FIG. 7B, which is the torque direction, the cylinder cams all engage on the hex nut.

FIG. 7C show the wrench when it is turned in the opposite direction, which is clockwise or the ratchet direction. In this case the tips of the nut points engage the cylinder cams differently, and just begin to rotate the cylinder cams against the torsion springs. In FIG. 7D, the cylinder cam rotation is complete and the wrench is ratcheting past the cylinder cams. The cylinder cam torsion springs will return the cylinder cams to their torque ready position as soon as the nut tips pass by the machined area of the cylinder cams.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. An adjustable open end wrench assembly with a ratchet feature comprising:
a) a wrench body with an opening designed to partially encompass a hex nut located on a tubing,
b) three cylindrical cams rotatably located about an inner periphery of said opening and are positioned to engage with a face of said hex nut 120 degrees apart when said open end wrench assembly is used in the torque direction,
c) wherein said cylindrical cams incorporate the following design features:
1) wherein said cylindrical cams are arranged to grip said hex nut when the wrench is turned in the torque direction and to ratchet when turned in the ratchet direction,
2) wherein a portion of said cylindrical cams is machined in a manner to provide for engagement with said hex nut for the purpose of rotating said cylindrical cams for a ratchet function, and
3) a spring which is associated with each said cylindrical cam, wherein a rotation of said cylindrical cam by said ratchet function causes said spring to deflect and create a counter rotating force,
d) two adjustable guide blocks, wherein each said adjustable guide block holds a cylindrical cam, wherein said adjustable guide blocks are adjustable in position to accommodate a varying size said hex nut,
e) wherein the movement of said adjustable guide blocks is activated by a rotation which moves a drive train, and
f) a top plate.

2. The adjustable open end wrench assembly according to claim 1 wherein said open end wrench assembly is secured by screws.

3. The adjustable open end wrench assembly according to claim 1 wherein a guide block top plate and a guide block bottom plate are attached to each said adjustable guide block.

4. The adjustable open end wrench assembly according to claim 1 wherein a pin and stop are incorporated into any said guide block bottom plate.

5. The adjustable open end wrench assembly according to claim 1 wherein a pin and stop are incorporated into said top plate.

6. The adjustable open end wrench assembly according to claim 1 wherein a pin and stop are incorporated into said wrench body for a fixed cylindrical rotating cam, wherein said pin and said stop are attached to a flat plate under said fixed cylindrical rotating cam.
